(19) United States
(12) Patent Application Publication
(10) Pub. No.: US 2003/0137973 A1
(43) Pub. Date: Jul. 24, 2003

(54) VoDSL integrated access device and control method thereof

(75) Inventors: Hyun Joon Kim, Gyeonggi-Do (KR); Kun Kook Park, Seoul (KR); Won Ju Yun, Gyeonggi-Do (KR); Eui Seok Kwon, Seoul (KR)

Correspondence Address: LEE & HONG, 801 SOUTH FIQUEROA STREET, 14TH FLOOR, LOS ANGELES, CA, 90017, US

(73) Assignee: LG Electronics Inc.

(21) Appl. No.: 10/315,793

(22) Filed: Dec. 10, 2002

(30) Foreign Application Priority Data
Dec. 13, 2001 (KR) PATENT-2001-79020

(51) Int. Cl. H04L 12/66; H04L 12/28

(52) U.S. Cl. 370/352; 370/401; 370/419

(57) ABSTRACT

In a VoDSL (voice over digital subscriber) IAD (integrated access device) and a control method thereof capable of performing voice communication by using a PSTN when it is impossible to perform voice communication through a VoDSL service network, the VoDSL IAD includes a DSL module connected to a VoDSL service network and providing data and voice communications to plural personal computers and telephone sets; a digital processing unit for converting a voice signal received from a telephone into a digital signal format or a voice signal having a digital signal format received from the DSL module into an analog signal format; a SLIC (subscriber line interface circuit) for outputting the digital signal format voice signal from the digital processing unit to the telephone or outputting the analog signal format voice signal from the telephone to the digital processing unit; and a switching logic for performing switching operation according to a power state and connecting the SLT to the PSTN network.

### BACKGROUND OF THE INVENTION

1. Field of the Invention

The present invention relates to a VoDSL (voice over digital subscriber) IAD (integrated access device) and a control method thereof, and in particular to a VoDSL IAD and a control method thereof capable of performing voice communication by using a PSTN when voice communication through a VoDSL service network is impossible.

2. Description of the Prior Art

In general, a holding frequency band of a telephone line is 6 KHz, however, only frequency band within 0˜3 KHz is actually used in voice communication.

xDSL is a technique for transmitting a certain data by using a not-used frequency band, and VoDSL (voice over digital subscriber) is a technique for providing voice data with a xDSL service through a telephone line.

Herein, in the VoDSL, because one copper circuit, namely, a xDSL has a capacity of maximum 24 telephone subscribers and plural data subscribers, it is a next generation voice telephone service capable of reducing a network construction cost epochally.

In addition, the VoDSL uses a DSL technique in dividing a copper circuit into a voice band and a data band, the DSL technique is based on an ATM which allocates a voice circuit (ATM layer 2) to a data circuit (ATM layer 5) additionally.

FIG. 1 is a block diagram illustrating a network of a VoDSL service.

As depicted in FIG. 1, the network includes a VoDSL (voice over digital subscriber) IAD (integrated access device) 106 located in a house of a subscriber in order to support voice and data communication of a PC 100, a general telephone set 102 and a facsimile through one telephone line, namely, copper circuit; a DSLAM (digital subscriber line access multiplexer) 108 located in a telephone office; and a voice gateway 110 located in a communication service provider side.

Herein, the VoDSL IAD 106 provides a xDSL matching function and an ATM matching function in order to support voice and data communication.

In addition, the DSLAM 108 transmits high speed data and voice data having a packet format received from the VoDSL IAD 106 to the voice gateway 110 through an ATM network.

The voice gateway 110 processes routing and certification related protocols of the high speed data traffic received through the ATM network, transmits it to a data network and transmits the received voice data to a PSTN network.

In the VoDSL service network, when it is impossible to increase telephone circuits due to physical limit of a copper line, by installing a 8 lines or 16 lines or 24 lines IAD 106, it is possible to connect a PC, a facsimile and a telephone through one copper line.

Herein, in order to send voice with data through the VoDSL service network, the IAD 106 codes a voice signal inputted from a telephone and converts the coded voice signal into a digital signal format.

In addition, in order to output a voice signal received from the VoDSL service network, the IAD 106 converts the received voice signal into an analog signal format and decodes the analog signal format.

As described above, in the conventional IAD, voice transmission/reception is performed through a digital processing process by using a digital signal processor for voice processing and a codec.

Accordingly, in the conventional IAD, when power is off, the above-mentioned operation can not be performed, and accordingly voice transmission/reception, namely, voice communication can not be performed.

### SUMMARY OF THE INVENTION

In order to solve the above-mentioned problem, it is an object of the present invention to provide a VoDSL IAD and a control method thereof capable of performing voice communication even in a power failure by using a SLT (single line terminal) therein.

In addition, it is another object of the present invention to provide a VoDSL IAD and a control method thereof capable of performing voice communication by using a SLT (single line terminal) according to a user's selection.

In order to achieve the above-mentioned objects, in a VoDSL (voice over digital subscriber) IAD (integrated access device) providing data and voice communication services to plural personal computers and telephone sets connected through a certain connector, a VoDSL IAD (integrated access device), in accordance with the present invention includes a DSL module connected to a VoDSL service network and providing data and voice communications to plural personal computers and telephone sets; a hub for providing data according to the data communication of the DSL module to the plural personal computers; a digital processing unit for converting a voice signal received from a telephone into a digital signal format or a voice signal having a digital signal format received from the DSL module into an analog signal format; a SLIC (subscriber line interface circuit) for outputting the digital signal format voice signal from the digital processing unit to the telephone or outputting the analog signal format voice signal from the telephone to the digital processing unit; a SLT (single line terminal) connected to a PSTN network through a general telephone line and providing a voice communication service; and a switching logic for performing switching operation according to a power state and connecting the SLT to the PSTN network.

Herein, the switching logic connects the SLT (single line terminal) to the PSTN network in a power-off state.

In a control method of a VoDSL (voice over digital subscriber) IAD (integrated access device) providing data communication and voice communication services to plural personal computers and telephone sets connected through a certain connector—the IAD includes a SLT (single line terminal) performing voice communication through a general telephone line-, a control method of a VoDSL IAD in accordance with the present invention includes judging whether it is possible to perform voice communication according to a VoDSL service when a user inputs a voice communication request signal; connecting a SLT (single line terminal) to a PSTN network through a general telephone line when it is impossible to perform voice communication according to the VoDSL service; and performing a call processing operation through the connected PSTN network.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a block diagram illustrating a network construction for providing a general VoDSL service;

FIG. 2 is a block diagram illustrating a construction of a VoDSL (voice over digital subscriber) IAD (integrated access device) in accordance with the present invention; and

FIG. 3 is a flow chart illustrating a VoDSL IAD control method in accordance with the present invention.

### DETAILED DESCRIPTION OF THE PREFERRED EMBODIMENT

Hereinafter, the preferred embodiment of a VoDSL VoDSL (voice over digital subscriber) IAD (integrated access device) and a control method thereof in accordance with the present invention will be described with reference to accompanying drawings.

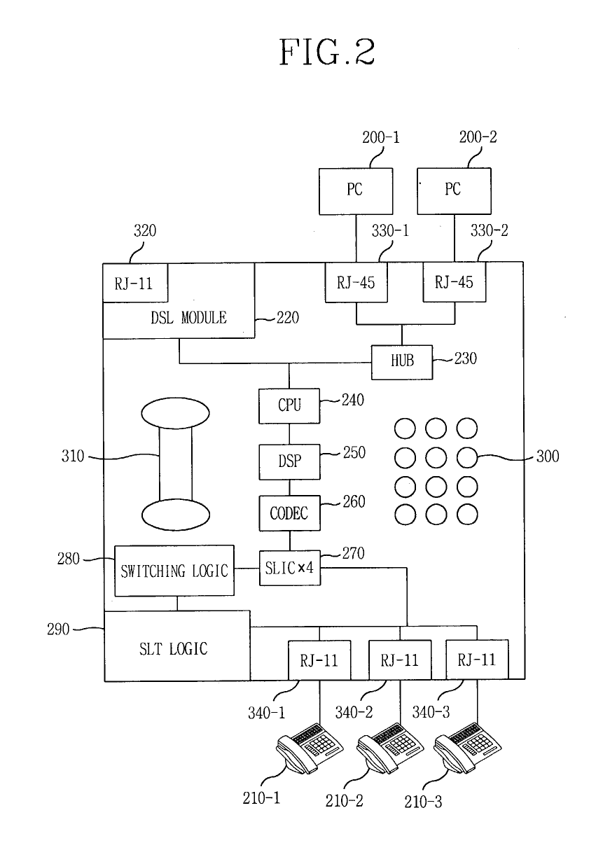

FIG. 2 is a block diagram illustrating a construction of a VoDSL IAD in accordance with the present invention.

As depicted in FIG. 2, the VoDSL VoDSL (voice over digital subscriber) IAD (integrated access device) in accordance with the present invention includes a DSL module 220 for providing high speed Internet communication and voice communication to a first and second PCs 200-1, 200-2 and a first third telephones 210-1, 210-2, 210-3; a hub 230 for providing data according to the high speed Internet communication provided from the DSL module 220 to the first and second PCs 200-1, 200-2; a CPU 240 for controlling digital processing of a voice signal through a VoDSL service; a DSP (digital signal processor) 250 for converting the voice signal having an analog signal format received from the first˜telephones 210-1, 201-2, 210-3 into a digital signal format; a codec 260 for coding the voice signal from the first˜telephones 210-1, 210-2, 210-3 or decoding the voice signal having the digital signal format inputted from the DSP 250; a SLIC (subscriber line interface circuit) 270 for distributing the signal inputted from the codec 260 to plural voice communication circuits; a switching logic 280 for selecting a voice communication circuit by sensing a power state; a SLT (single line terminal) 290 operated by the switching logic 280 and performing an operation for voice communication through a PSTN network; a key pad 300; and a hand set is 310.

Herein, the DSL module 220 is connected to a physical telephone circuit through a first connector 320, the first and second PCs 200-1, 200-2 are connected to the hub 230 through a first and second USB connectors 330-1, 330-2, and the first˜third telephones 210-1, 210-2, 210-3 are connected to the SLIC 270 through a second˜fourth telephone connectors 340-1, 340-2, 340-3.

Herein, the physical telephone circuit connected to the DSL module 220 through the first connector 320 includes a DSL line for providing the VoDSL service and a general telephone line for providing a general voice communication service. In addition, the first˜third telephones 210-1, 210-2, 210-3 are connected to the SLIC 270 and have an extension number different from each other in voice communication according to the VoDSL service.

The switching logic 280 is constructed as a relay for connecting the SLT logic 290 to the first connector 320 automatically in a power failure, namely, a power-off state of the IAD.

The SLT logic 290 has a construction for voice communication except a key pad and a hand set, and it receives a call signal and a voice signal from the key pad 300 and the hand set 310 of the VoDSL IAD in voice communication.

In addition, the SLT logic 290 is connected to a general telephone packet network (AAL2 or AAL5), namely, the PSTN network through the first connector 320 in a power failure.

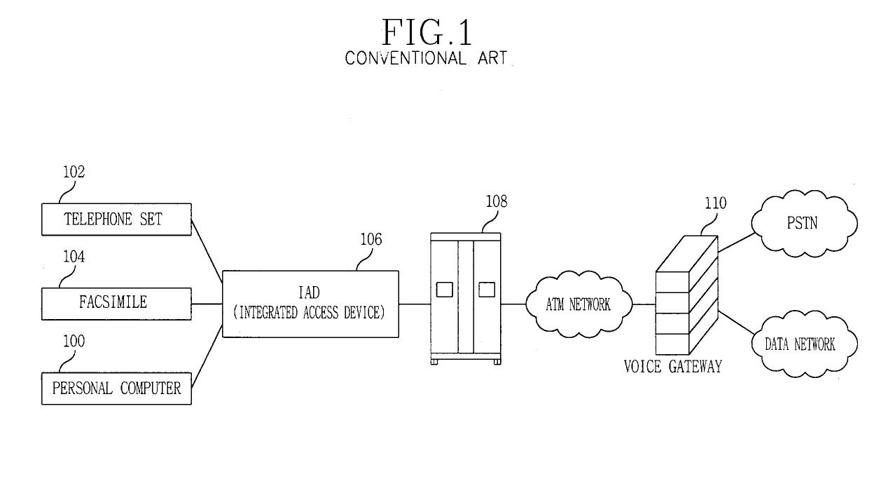

The operation of the VoDSL IAD in accordance with the present invention will be described with reference to the VoDSL service network in FIG. 1.

The DSL module 220 is connected to the DSL line through the first connector 320, receives a packet, when the received packet is a data packet according to Internet communication, it provides the received data to the first and second PCs 200-1, 200-2 through the hub 230.

In the meantime, when the packet received through the DSL line is a voice packet for voice communication, the DSL module 220 outputs the received voice packet to the CPU 240, the CPU 240 outputs the voice packet received from the DSL module 220 to the DSP 250 with a control signal for converting the voice packet into an analog voice signal format.

By the control signal from the CPU 240, the DSP 250 converts the received voice packet into an analog signal format voice signal and outputs it to the codec 260, the codec 260 decodes the voice signal received from the DSP 250 and outputs the voice signal to the SLIC 270 of a pertinent telephone of the first˜third telephones 210-1, 210-2, 210-3 in which a communication channel is set.

In the meantime, when a user inputs a voice signal by using the first telephone 210-1, the SLIC 270 outputs the voice signal inputted from the first telephone 210-1 to the codec 260, and the codec 260 codes the voice signal and outputs it to the DSP 250.

The DSP 250 receives the coded voice signal from the codec 260, converts the voice signal into a digital signal format which is following the standard (Example: G.723, G.729) by the control of the CPU 240 and outputs it to the DSL module 220.

The DSL module 220 constructs the digital signal format voice signal recieved from the DSP 250 through the CPU 240 as a packet format and transmits it to the DSLAM 108 of the telephone office through the telephone line connected through the first connector 320.

In addition, when data for Internet communication is inputted from the first and second PCs 200-1, 200-2 through the hub 230, the DSL module 220 constructs the inputted data as a packet format and transmits it to the DSLAM 108 of the telephone office.

The DSLAM 108 divides the received packet into a voice packet requiring a real time transmission and a data packet and transmits the divided voice and data packets to the voice gateway 110.

The voice gateway 110 transmits the received voice packet to the PSTN network, processes routing and certification related protocols of the received data packet and transmits the data packet to the data network.

When a call request signal is inputted from the user, the switching logic 280 judges whether power is supplied to the VoDSL IAD.

Herein, when power is not supplied to the IAD because of a power failure, etc., the switching logic 280 connects the SLT logic 290 to the PSTN network through the first connector 320.

In more detail, the SLT logic 290 is connected to a general telephone line through the first connector 320 and is connected to the PSTN network through the general telephone line.

Herein, the SLT logic 290 connected to the PSTN network is operated by power different from power of the VoDSL IAD, namely, power supplied through the general telephone line from the telephone office, and accordingly voice communication can be performed even in a power failure. Herein, the SLT logic 290 receives a call signal and a voice signal inputted by the user through the hand set 310 and the key pad 300.

In addition, the first˜third telephones 210-1, 210-2, 210-3 connected to the VoDSL IAD through the second˜fourth connectors 340-1, 340-2, 340-3 are connected to the same telephone line with the SLT logic 290.

In more detail, because the first˜third telephones 210-1, 210-2, 210-3 are connected to the telephone line through the first connector 320, they have not extension numbers different from each other but the same telephone number.

In the meantime, besides a connection in a power failure, the SLT logic 290 can be connected to the telephone line through the first connector 320 and can perform voice communication according to a circuit selection signal inputted by the user.

In more detail, by constructing a circuit selection switch on the VoDSL IAD or displaying circuit selection information through an information display window (not shown) of the VoDSL IAD, the SLT logic 290 receives the circuit selection signal from the user through the circuit selection switch or the selection information displayed on the information display window.

Afterward, the SLT logic 290 is connected to the general telephone network through the first connector 320 according to the circuit selection signal and performs the voice communication.

In addition, when voice communication through the VoDSL service is impossible due to network conditions except a power failure, the SLT logic 290 is automatically connected to the general telephone network through the first connector 320 and performs voice communication.

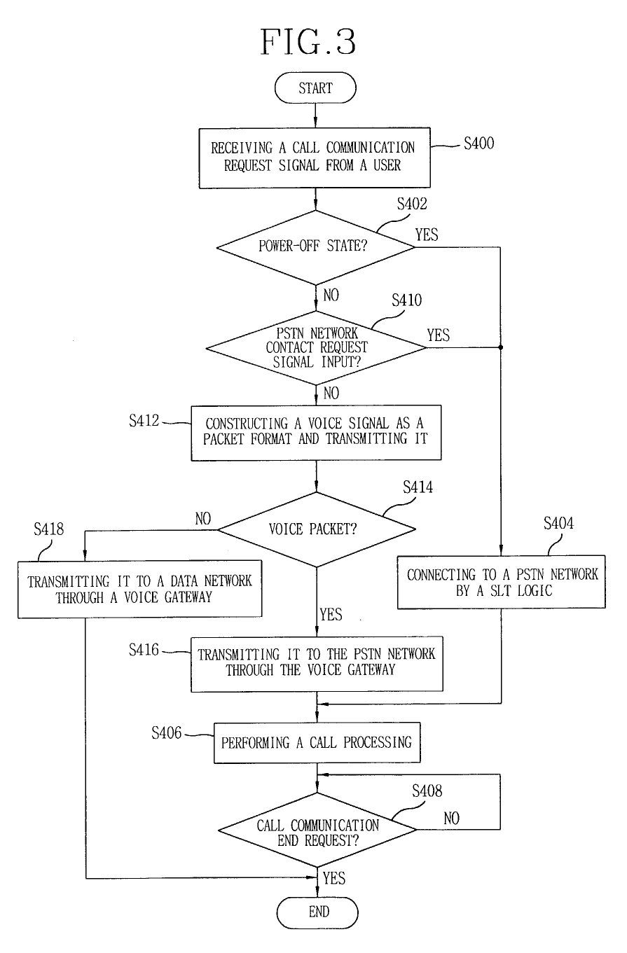

A control method of the VoDSL IAD in accordance with the present invention will be described with reference to FIG. 3.

FIG. 3 is a flow chart illustrating a VoDSL IAD control method in accordance with the present invention.

First, when a user picks up the hand set 310 and a telephone communication request signal is inputted as shown at step S400, the switching logic 280 judges whether it is a power-off state (power is not supplied) as shown at step S402.

In the judging step S402, when it is judged as a power-off state, the switching logic 280 connects the SLT 290 to the PSTN network through the first connector 320 as shown at step S404.

Then, the VoDSL IAD performs a call processing operation using the SLT logic 290 connected to the PSTN network as shown at step S406, when the user requests a call end as shown at step S408, the call communication is finished.

In the meantime, in the judging step S402, when it is not a power-off state, it is judged whether a telephone network selection signal for a general telephone network connection is inputted from the user as shown at step S410.

When a telephone network selection signal for a general telephone network connection, namely, the PSTN network connection is inputted from the user, as described above, the switching logic 280 connects the SLT 290 to the PSTN network through the first connector 320 as shown at step S404, and the call communication is performed through the call processing process.

In the meantime, when a telephone network selection signal for a general telephone network connection is not inputted from the user, the VoDSL IAD is connected to the DSL line through the first connector 320.

The VoDSL IAD converts the voice signal inputted through the hand set 310 into a digital signal format through the SLIC 270, the codec 260, the DSP 250 and the CPU 240, constructs the digital signal format voice signal as a packet format through the DSL module 220 and transmits it to the DSLAM 108 of the telephone office through the DSL line.

The DSLAM 108 judges whether the received packet is a voice packet requiring a real time transmission or a data packet as shown at step S414.

In the judging step S414, when the received packet is a voice packet, the DSLAM 108 transmits the received voice packet to the PSTN network through the voice gateway 110 as shown at step S416, performs a call processing operation as well as the general telephone call processing as shown at step S406, maintains a communication state until there is a communication end request, when a communication end is requested as shown at step S408, the DSLAM 108 ends the pertinent communication.

In the meantime, in the judging step S414, when the received packet is a data packet, the DSLAM 108 transmits the received data packet to the data network through the voice gateway 110 as shown at step S418 and provides Internet service to the first and second PCs 200-1, 200-2.

As described above, in the present invention, when a voice communication can not be performed through a DSL line for a VoDSL service due to a power failure or a network condition, by directly connecting to a PSTN network according to a SLT logic constructed in a VoDSL IAD, it is possible to perform voice communication.

Therefore, because it is possible to perform voice communication by using the VoDSL IAD even in emergency situations such as a power failure, etc., reliability of the VoDSL IAD can be improved.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. In a VoDSL (voice over digital subscriber) IAD (integrated access device) providing data and voice communication services to plural personal computers and telephone sets connected through a certain connector, a VoDSL IAD (integrated access device), comprising:
a DSL module connected to a VoDSL service network and providing data and voice communications to plural personal computers and telephone sets;
a hub for providing data according to the data communication of the DSL module to the plural personal computers;
a digital processing unit for converting a voice signal received from a telephone into a digital signal format or a voice signal having a digital signal format received from the DSL module into an analog signal format;
a SLIC (subscriber line interface circuit) for outputting the digital signal format voice signal from the digital processing unit to the telephone or outputting the analog signal format voice signal from the telephone to the digital processing unit;
a SLT (single line terminal) connected to a PSTN network through a general telephone line and providing a voice communication service; and
a switching logic for performing switching operation according to a power state and connecting the SLT to the PSTN network.

2. The IAD of claim 1, wherein the switching logic connects the SLT (single line terminal) to the PSTN network in a power-off state.

3. The IAD of claim 1, wherein the SLT performs voice communication by power supplied from a general telephone line of the PSTN network.

4. The IAD of claim 1, wherein the switching logic connects the SLT to the PSTN network when an error occurs in the VoDSL service network or a network selection signal is received from a user.

5. The IAD of claim 1, further comprising:
a network selection switch for outputting a network selection signal for connecting the SLT to the PSTN network or a PSTN network contact selection program.

6. The IAD of claim 1, wherein the switching logic is constructed as a relay for connecting the SLT to the PSTN network automatically in a power-off state.

7. The IAD of claim 1, wherein the digital processing unit includes:
a CPU for controlling digital-processing of a voice signal for voice communication;
a DSP (digital signal processor) for converting a voice signal from the DSL module into an analog signal format or converting a voice signal from the telephone into a digital signal format by the control of the CPU; and
a codec for decoding the analog signal format voice signal received from the DSP or coding the voice signal received from the telephone and outputting it to the DSP.

8. In a control method of a VoDSL (voice over digital subscriber) IAD (integrated access device) providing data communication and voice communication services to plural personal computers and telephone sets connected through a certain connector, wherein the IAD includes a SLT (single line terminal) performing voice communication through a general telephone line, a control method of a VoDSL IAD, comprising:
judging whether it is possible to perform voice communication according to a VoDSL service when a user inputs a voice communication request signal;
connecting a SLT (single line terminal) to a PSTN network through a general telephone line when it is impossible to perform voice communication according to the VoDSL service; and
performing a call processing operation through the connected PSTN network.

9. The control method of claim 8, wherein it is impossible to perform voice communication according to the VoDSL service when power is off or error occurs in a VoDSL service network.

10. The control method of claim 9, further comprising:
receiving a PSTN network selection signal from the user; and
connecting the SLT to the PSTN network through the general telephone line according to the PSTN network selection signal.

11. The control method of claim 8, wherein the SLT performs voice communication by power supplied from the general telephone line of the PSTN network.
